(19) United States
(12) Patent Application Publication
(10) Pub. No.: US 2013/0191147 A1
(43) Pub. Date: Jul. 25, 2013

(54) METHOD AND SYSTEM FOR PROMOTING MEDICATIONS

(71) Applicant: OPTIMIZERX CORPORATION, Rochester, MI (US)

(72) Inventor: David A. Harrell, Shelby Township, MI (US)

(21) Appl. No.: 13/790,936

(22) Filed: Mar. 8, 2013

Related U.S. Application Data
(63) Continuation-in-part of application No. 13/691,053, filed on Nov. 30, 2012.
Application No. 13/691,053 is a division of application No. 12/655,558, filed on Dec. 31, 2009, now Pat. No. 8,341,015.
(60) Provisional application No. 61/273,960, filed on Aug. 11, 2009.
(60) Provisional application No. 61/277,161, filed on Sep. 21, 2009.
(60) Provisional application No. 61/608,190, filed on Mar. 8, 2012.

(51) Int. Cl. G06Q 30/02; G06Q 50/22

(52) U.S. Cl. CPC G06Q 30/0207; G06Q 50/22
USPC 705/2

(57) ABSTRACT

A method for promoting prescription medication, comprising: receiving, by an electronic prescribing application, a request for information regarding a medication from a healthcare provider; retrieving information for a given medication which satisfies the request, where the retrieved information includes an indicia of a financial incentive associated with the given medication; presenting the given medication, along with the indicia, on a display; receiving an indication that the given medication is to be prescribed to a patient by the healthcare provider; requesting information regarding the financial incentive from a server; receiving the information regarding the financial incentive from the server; presenting the information regarding the financial incentive on the display; and sending a prescription for the given medication electronically to a pharmacy, where the prescription includes a portion of the information regarding the financial incentive.

### CROSS-REFERENCE TO RELATED APPLICATIONS

This application is a continuation-in-part of U.S. patent application Ser. No. 13/691,053 filed on Nov. 30, 2012 which is a divisional of U.S. application Ser. No. 12/655,558 filed on Dec. 31, 2009 (now U.S. Pat. No. 8,341,015) which claims the benefit of U.S. Provisional Application No. 61/273,960 filed on Aug. 11, 2009 and U.S. Provisional Application No. 61/277,161 filed on Sep. 21, 2009. This application also claims the benefit of U.S. Provisional Application No. 61/608,190 filed on Mar. 8, 2012. The entire disclosure of the above applications are incorporated herein by reference.

### FIELD

The present disclosure relates generally to promotion medications, and more specifically to a method and system for promoting medications through promotional offers.

### BACKGROUND

Recent developments in pharmaceuticals have led to the development of medications that can treat or alleviate many medical conditions or diseases that were incurable in the past. Some pharmaceutical companies that manufacture medications expend vast capital resources towards research and development. Most of the cost associated with extensive research and development is passed on to patients in the form of higher prices for medications.

Furthermore, due to the sheer number of medications available for some diseases, it is difficult for healthcare providers and patients to discover medications that might be cheaper than the medication that they found. It is desirable to present the healthcare provider with information regarding promotional offers for medications while the healthcare provider is in the process of prescribing a medication to a patient, so that the healthcare provider may choose to prescribe a medication that has a promotional offer in order to reduce the cost to the patient.

This section provides background information related to the present disclosure which is not necessarily prior art.

### SUMMARY

A method is presented for promoting prescription medication. The method includes: receiving a request for information regarding a medication from a healthcare provider; retrieving information for a given medication which satisfies the request for information, where the information for the given medication includes an indicia of a financial incentive associated with the given medication and the retrieval being performed in response to the request for information; presenting the given medication, along with the indicia of a financial incentive, on a display; receiving an indication that the given medication is to be prescribed to a patient by the healthcare provider; requesting information regarding the financial incentive, the request being transmitted over a network to a server and the request being performed in response to receiving the indication that the given medication is to be prescribed; receiving the information regarding the financial incentive from the server; presenting the information regarding the financial incentive on the display; and sending a prescription for the given medication electronically to a pharmacy, where the prescription includes a portion of the information regarding the financial incentive and the electronic prescribing application is implemented by computer-readable instructions executed by a computer processor residing on a host computing device.

This section provides a general summary of the disclosure, and is not a comprehensive disclosure of its full scope or all of its features. Further areas of applicability will become apparent from the description provided herein. The description and specific examples in this summary are intended for purposes of illustration only and are not intended to limit the scope of the present disclosure.

### DRAWINGS

FIG. 1 is a block diagram illustrating an example system for promoting and prescribing medications;

FIG. 2 is a block diagram illustrating an example electronic prescribing application and an example financial incentive support application;

FIG. 3 is a flow diagram illustrating an example method for receiving identifiers of medications with promotional offers;

FIG. 4 is a flow diagram illustrating an example method for promoting and prescribing medications;

FIG. 5 is a diagram illustrating an example user interface that a healthcare provider uses to search for medications;

FIG. 6 is a diagram illustrating another example user interface that a healthcare provider uses to prescribe medications;

FIG. 7 is a diagram illustrating another example user interface that a healthcare provider uses to view information regarding promotional offers and to send a prescription to a pharmacy; and

FIG. 8 is a diagram illustrating an example prescription generated by the electronic prescribing application.

The drawings described herein are for illustrative purposes only of selected embodiments and not all possible implementations, and are not intended to limit the scope of the present disclosure. Corresponding reference numerals indicate corresponding parts throughout the several views of the drawings.

### DETAILED DESCRIPTION

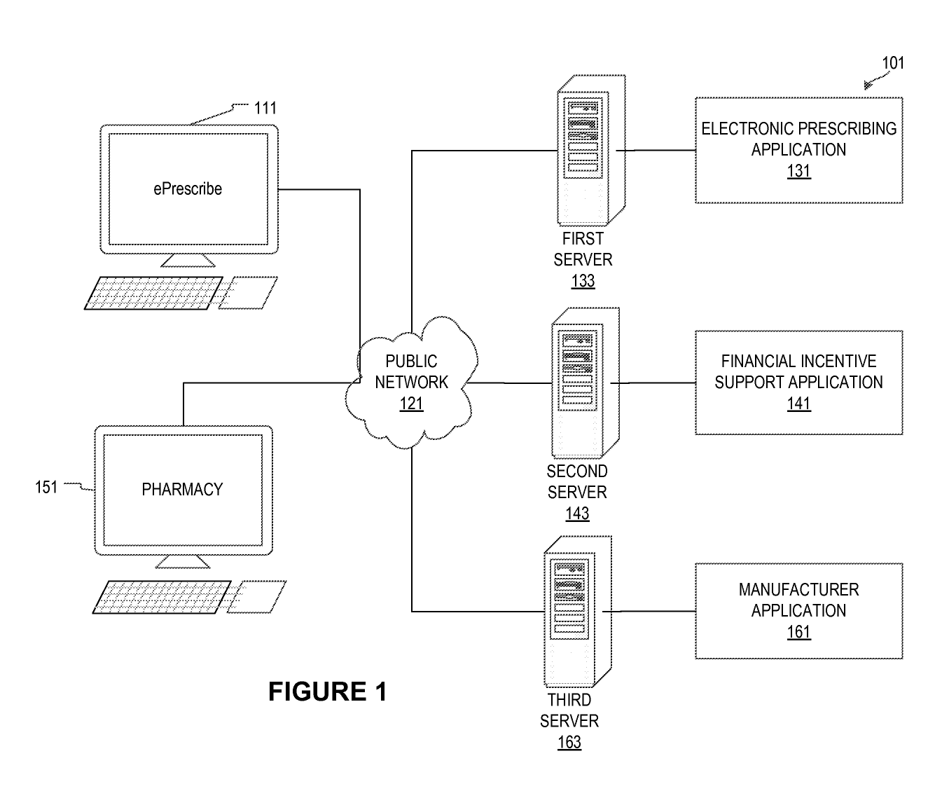

FIG. 1 illustrates an example system 101 for promoting and prescribing medications. The system 101 generally comprises a healthcare provider device 111, an electronic prescribing application 131 that is accessible to healthcare providers through the healthcare provider device 111, a financial incentive support application 141 that provides promotional offers for medications to healthcare providers via the electronic prescribing application 131, and a pharmacy device 151 that electronically receives prescriptions for medications from the electronic prescribing application 131. The healthcare provide device 111, the electronic prescribing application 131, the financial incentive support application 141, and the pharmacy device 151 electronically communicate with each other over a public network 121. The public network 121 includes the Internet.

The electronic prescribing application 131 is used by healthcare providers to access patient records, search for medications, prescribe medications to patients and to electronically send prescriptions to the pharmacy device 151. The electronic prescribing application 131 is hosted on a first server 133 that is connected to the public network 121. The first server 133 includes a communication module for communicating with the public network 121. In an example embodiment, the communication module includes a wired communication channel such as Ethernet or a wireless communication channel such as the cellular network. In another example embodiment, the communication module includes other communication channels for electronically communicating with the public network 121. The first server 133 includes a processor, a memory, an input device and an output device. The processor is connected to the memory, the input device and the output device. In an example embodiment, the processor includes a general purpose processor. In another example embodiment, the processor includes an application specific integrated circuit. The input device includes a keyboard, a mouse, a touchpad, a trackpad, or the like. The output device includes a display, a speaker, or the like.

Healthcare providers access the electronic prescribing application 131 by using the healthcare provider device 111. The healthcare provider device 111 includes a desktop computer located in the healthcare provider's office. In an example embodiment, the healthcare provider device 111 includes a laptop computer, or a mobile communication device such as an electronic tablet or a smart phone. The healthcare provider device 111 is connected to the public network 121 and accesses the electronic prescribing application 131 and various external resources through the public network 121. Examples of external resources that the healthcare provider device 111 accesses through the public network 121 include websites of medication manufacturers, websites of healthcare insurance providers, electronic prescription systems such as ePrescribe, etc. In an example embodiment, the healthcare provider device 111 is directly connected to the public network 121. In another example embodiment, the healthcare provider device 111 is connected to the public network 121 through a private network, for example the private network in the physician's office. In another example embodiment, the healthcare provider device 111 connects to the public network 121 through a wired connection such as Ethernet or through wireless communications such as the cellular network, Wireless Local Area Network (WLAN), Bluetooth or the like.

The financial incentive support application 141 transmits promotional offers for medications to the electronic prescribing application 131 which then presents the promotional offers to the healthcare providers. The financial incentive support application 141 is hosted on a second server 143 and is accessible by the electronic prescribing application 131 over the public network 121. The financial incentive support application 141 stores promotional offers, such as financial incentives, for prescription medications that a healthcare provider may prescribe to a patient. Financial incentives can include but are not limited to coupons, voucher, co-pays, or the like. While specific reference is made throughout the application to financial incentives, the concepts described here relate more generally to any type of promotional offer. Moreover, the infrastructure described herein may be used to deliver other types of information, such as product information, disease information and patient educational information.

In an example embodiment, access to the financial incentive support application 141 may be restricted so that only authorized users can access the financial incentive support application 141 and obtain information regarding financial incentives associated with a given prescription medication. In an example embodiment, a physician or a hospital may have to pay a fee to access the financial incentive support application 141 through the electronic prescribing application 131. The physician or the hospital that has paid the fee to access the financial incentive support application 141 can entice patients to come to the physician's office to obtain financial incentives for prescription medications.

The electronic prescribing application 131 generates a prescription and electronically sends the prescription to the pharmacy device 151. The electronic prescribing application 131 includes a portion of the promotional offer in the prescription that is sent to the pharmacy device 151. The pharmacy device 151, located at a pharmacy, receives electronic prescriptions from the electronic prescribing application 131. The healthcare provider device 111 uses the electronic prescribing application 131 to generate a prescription for a patient and sends the generated prescription to the pharmacy device 151 over the public network 121. In an example embodiment, the healthcare provider device 111 generates a prescription for a patient and electronically sends the prescription to the pharmacy device 151. In another example embodiment, the healthcare provider device 111 or the electronic prescribing application 131 generates a prescription, electronically sends the prescription to the patient and the patient electronically sends the prescription to the pharmacy device 151 located at a pharmacy of the patient's choice. The prescription received by the pharmacy device 151 includes a portion of the financial incentive (e.g., coupon code from the manufacturer) retrieved from the financial incentive support application 141. The pharmacy device 151 applies the financial incentive to the prescription. For example, if the financial incentive includes a $10 coupon or the prescribed medication, then the pharmacy device 151 subtracts $10 from the cost of the medication. Advantageously, the patient or the patient's healthcare insurance company pays a lesser amount for the medication thereby reducing healthcare costs.

The system 101 may include a manufacturer application 161 that provides promotional offers for medications to the financial incentive support application 141. The manufacturer application 161 is hosted on a third server 163. The financial incentive support application 141 accesses the manufacturer application 161 and obtains information regarding financial incentives associated with medications manufactured by the manufacturer. In an example embodiment, the financial incentive support application 141 periodically retrieves financial incentives associated with the manufacturer's medication products. In an example embodiment, the financial incentive support application 141 accesses different manufacturer applications corresponding with different manufacturers and retrieves financial incentives associated with each manufacturer's medication products.

Access to the electronic prescribing application 131 may be restricted and the healthcare provider device 111 may prompt the healthcare provider to provide login credentials to access the electronic prescribing application 131. In an example embodiment, the healthcare provider device 111 accesses the electronic prescribing application 131 through a web-based user interface over the public network 121. In the example embodiment, a healthcare provider is a physician. The healthcare provider can also include a nurse, an assistant to the physician, a medical resident, a medical student, or the like. A healthcare provider who is an authorized user is provided with an authorization token. The authorized user includes the authorization token in requests that are made from the electronic prescribing application 131 to the financial incentive support application 141 on behalf of the authorized user. Upon receiving a request with an authorization token embedded in the request, the financial incentive support application 141 authenticates the authorization token by verifying the authorization token's authenticity and grants the request if the authorization token is an authentic token.

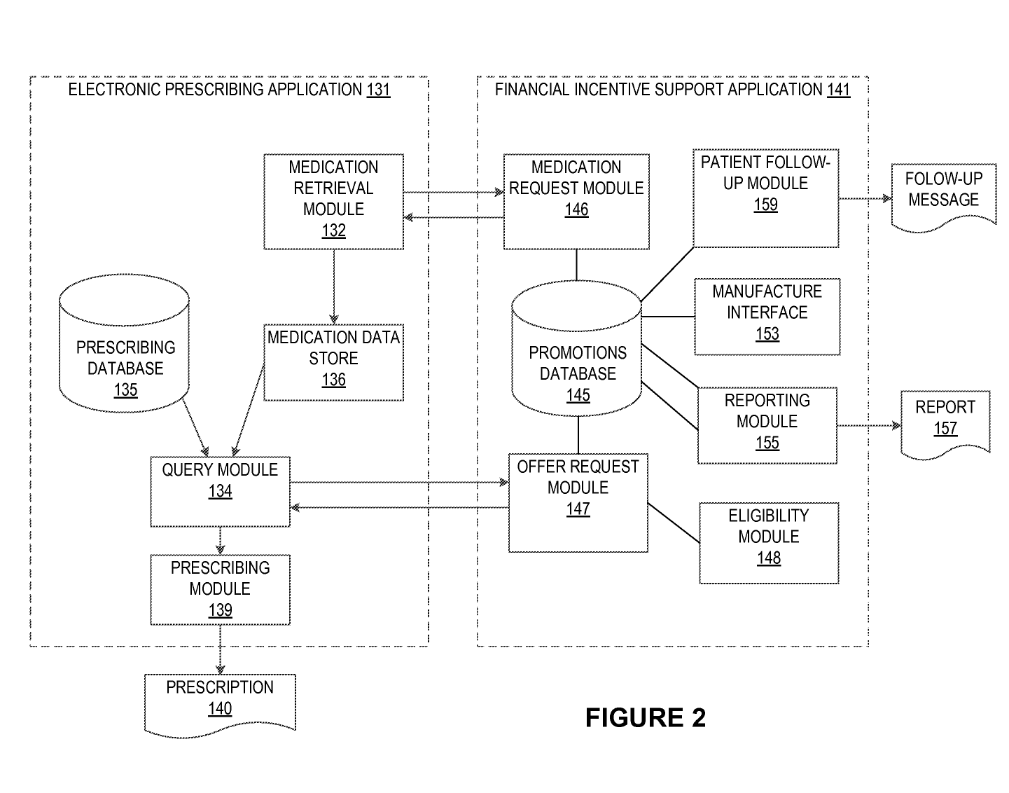

FIG. 2 further depicts an example embodiment of an electronic prescribing application 131 interfaced with a financial incentive support application 141. The electronic prescribing application 131 generally includes a medication retrieval module 132, a query module 134, a prescribing database 135, and a prescribing module 139.

The medication retrieval module 132 retrieves identifiers of medications with financial incentives from the financial incentive support application 141. In an example embodiment, the identifiers are names of the medications. The identifiers can also include generic names of the medications, brand names of the medications, serial numbers of the medications, chemical formula of the medications, images of the packaging of the medications, or any other character, string, or image that can be used identify the medications. In an example embodiment, the medication retrieval module 132 retrieves a listing of medications that have an associated financial incentive. In an example embodiment, the medication retrieval module 132 retrieves indicia indicating the availability of a financial incentive along with the identifiers of the medications. In an example embodiment, the indicia includes a portion of the financial incentive but not the entire financial incentive. In an example embodiment, the indicia indicates that there is a coupon or a voucher associated with the medication but does not include the coupon code required to make use of the coupon. In another example embodiment, the indicia includes an amount such as the value of the coupon or the voucher. In another example embodiment, the indicia indicates who is eligible for the financial incentive. For example, the indicia indicates that the financial incentive is available for senior citizens or for patients with low family income, etc.

The medication retrieval module 132 stores the identifiers of medications and indicia indicating the availability of financial incentives in a medication data store 136. In an example embodiment, the medication data store 136 is a cache or a memory of the first server 133. Advantageously, by storing or caching the identifiers of medications having a financial incentive, the electronic prescribing application 131 can present indicia indicating the availability of a financial incentive for a medication to the healthcare provider device 111 without having to retrieve the financial incentive availability information from the financial incentive support application 141 every time the healthcare provider device 111 requests the financial incentive availability information, thereby reducing system latency and increasing system performance.

During the course of treating patients, a healthcare provider may access the electronic prescribing application 131 to research and/or prescribe medications to patients. Queries from the healthcare provider are handled by the query module 134. For example, the query module 134 may receive queries for information regarding a given medication from a healthcare provider. The query module 134 in turn will retrieve information for the given medication from the prescribing database 135. In addition, the query module 134 will determine whether the given medication is stored in the medication data store 136 and thus has a financial incentive associated with it. If the given medication is stored in the medication data store 136, then the query module 134 retrieves the indicia associated with the given medication from the medication data store 136. The query module 134 presents the information regarding the given medication, along with the indicia for the financial incentive, to the healthcare provider that made the query. In an example embodiment, the query module 134 formats the information regarding the medication so that it appears in a particular manner when it is displayed on a display of the healthcare provider device 111. In an example embodiment, the query module 134 selects indicia to indicate that there is a financial incentive associated with a given medication, instead of retrieving the indicia from the medication data store 136.

The prescribing database 135 stores information regarding prescription medication products. The information regarding the prescription medications is received from medication manufacturers. In an example embodiment, the information regarding the medication is received from the manufacturer application 161. In another example embodiment, the electronic prescribing application 131 periodically retrieves the information regarding medications from the manufacturer application 161. In another example embodiment, the information regarding the prescription medications is entered manually into the electronic prescribing application 131. For example, manufacturers access the electronic prescribing application 131 and write information regarding their corresponding medications into the prescribing database 135. The information regarding the medications includes medicinal information such as medicinal ingredients. In an example embodiment, the information includes dosage information, prescription guidelines such as when to prescribe the medication, or the conditions or diseases for which the medication is normally prescribed.

The prescribing module 139 generates a prescription 140 and electronically sends the prescription 140 to the pharmacy device 151 over the public network 121. The prescribing module 139 generates the prescription 140 in response to receiving an indication from the healthcare provider device 111 that the healthcare provider wants to prescribe a given medication to a patient. In an example embodiment, the prescribing module 139 generates the prescription 140 by completing a prescription form. The prescribing module 139 retrieves information about the patient and the medication that is being prescribed from the prescribing database 135 and uses that information to populate fields in a prescription form. For example, the prescribing module 139 populates a name field, an allergies field, an insurance field, a medication field, a dosage field, a frequency field, or a notes field in the prescription with information provided by the healthcare provider device 111 or retrieved from the prescribing database 135. In an example embodiment, the prescription 140 generated by the prescribing module 139 is formatted by the prescribing module 139 so that the prescription 140 appears in a particular manner when the prescription 140 is displayed on a display of the pharmacy device 151 or the healthcare provider device 111. In an example embodiment, the prescribing module 139 changes a heading, a background or a watermark of the prescription 140 to include a name or a phone number of the physician who prescribed the medication. In one embodiment, the prescribing module 140 instructs the first server 133 to electronically send the completed prescription 140 to the pharmacy device 151. In other embodiments, the prescribing module 140 instructs the first server 133 to electronically send the completed prescription to a patient device so that the patient may send the prescription to a pharmacy device 151 corresponding with a pharmacy of the patient's choice.

The financial incentive support application 141 generally includes a medication request module 146, a promotions database 145, an offer request module 147 and an eligibility module 147.

The medication request module 146 receives a request for identifiers of medications with financial incentives from the electronic prescribing application 131. In an example embodiment, the medication request module 146 receives a request for a listing of medications with financial incentives. In an example embodiment, the medication request module 146 receives a request for all medications with a financial incentive. In another example embodiment, the medication request module 146 receives a request for medications that satisfy a particular criterion. In an example embodiment, the criteria include a medical ingredient, a disease, a symptom, or the like. For example, the medication request module 146 can receive a request for identifiers of medications that can be prescribed for migraine and that have a financial incentive associated with them. In response to receiving the request, the medication request module 146 accesses the promotions database 145 and retrieves identifiers of medications that have financial incentives and satisfy any given criterion. In an example embodiment, the medication request module 146 retrieves indicia from the promotions database 145, the indicia indicates the availability of financial incentives. The medication request module 146 instructs the second server 143 to transmit the identifiers of medications with financial incentives along with indicia indicating the financial incentive to the electronic prescribing application 131.

The promotions database 145 stores identifiers of medications, indicia indicating availability of promotional offers and promotional offers associated with the medications. Promotional offers include financial incentives such as coupons, vouchers, copays, or the like. In an example embodiment, the promotions database 145 stores different indicia for indicating different financial incentives. For example, a ‘C’ for coupon or a copay and a ‘V’ for voucher. In another example embodiment, the indicia includes a ‘$’ sign for indicating the financial incentive. In another example embodiment, the indicia include different indicia for indicating different amounts of financial incentives. For example, the indicia includes a ‘$$$’ sign to indicate a relatively large financial incentive and a ‘$’ sign to indicate a relatively small financial incentive. In another example, ‘$$$’ indicates a coupon for a 75% discount for eligible patients, whereas ‘$’ indicates a 25% discount.

The offer request module 147 receives a request for information regarding a financial incentive for a given medication from the electronic prescribing application 131. The offer request module 147 uses the eligibility module 148 to determine whether the request is eligible for the information. If the request is eligible, then the offer request module 147 retrieves the information from the promotions database 145 and transmits the information to the electronic prescribing application 131. If the request is not eligible, then the offer request module 147 does not transmit the information. In an example embodiment, if the request is not eligible, then the offer request module 147 may transmit an explanation explaining the ineligibility of the request. In an example embodiment, if the request is not eligible, then the offer request module 147 may transmit the information along with a warning indicating that the patient may not be able to make use of the financial incentive because the patient is not eligible. The offer request module 147 instructs the second server 143 to transmit the information regarding the financial incentive to the electronic prescribing application 131 over the public network 121. The request for information regarding a financial incentive includes a request for details regarding the financial incentive. In an example embodiment, the information includes a financial incentive identifier that can be used to redeem the financial incentive and reduce the cost of a medication. The financial incentive identifier includes a manufacturer identifier that the manufacturer of the medication has assigned to the financial incentive. In an example embodiment, the financial incentive identifier includes a coupon code that can be entered or scanned at a point of sale terminal at a pharmacy to reduce the cost of the medication. In an example embodiment, the information regarding the financial incentive includes a type of the financial incentive, for example whether the financial incentive is a coupon or a voucher. In another example embodiment, the information includes an amount of the financial incentive, for example a $10 coupon. In another example embodiment, the information includes a percentage discount, for example, a 25% discount coupon. In another example embodiment, the information includes an eligibility criterion that indicates whom the financial incentive is available to, for example the eligibility criterion can indicate that the financial incentive is available to seniors, to patients with a particular healthcare insurance plan, to patients with no healthcare insurance plan, to patients with a low income, etc.

The eligibility module 148 determines the eligibility of the request for information regarding the financial incentive. Some financial incentives include an eligibility criterion and the eligibility module 148 determines whether the eligibility criterion is satisfied. If the eligibility criterion is satisfied, then the eligibility module 148 notifies the offer request module 147 that the eligibility criterion is satisfied. If the eligibility criterion is not satisfied, then the eligibility module 148 notifies the offer request module 147 that the eligibility criterion is not satisfied. Examples of patient eligibility criterion are a patient being prescribed a given medication for the first time, a patient being a repeat customer of a given medication, a patient being a senior citizen, a patient being a child, a patient being without a healthcare insurance plan, a patient having low income, or a patient with a terminal illness. In an example embodiment, the eligibility criterion is set by the manufacturer of the medication, for example to promote the sale of the given medication or as a charitable endeavor by the manufacturer. In another example embodiment, the eligibility criterion is set by a statute, for example to provide terminally ill patients with a coupon as a matter of public policy or to provide a patient with low income with a discount coupon to make the medication more affordable for the low income patient. In an example embodiment, the eligibility criterion includes a healthcare provider eligibility criterion. An example of a healthcare provider eligibility criterion includes the healthcare provider being a physician having a particular specialty such as Cardiology, Internal Medicine, etc.

The financial incentive support application 141 may include a manufacture interface 153 for receiving promotional offers for medications from manufacturers and storing the promotional offers in the promotions database 145. In an example embodiment, the manufacture interface 153 includes a web-based user interface that a representative of a manufacturer can access and can use to manually enter information about promotional offers or specify eligibility criterion for a promotion offer. In another example embodiment, the manufacture interface 153 includes the manufacturer application 161 that can write information regarding financial incentives into the promotions database 145. In another example embodiment, the manufacture interface 153 retrieves information regarding the financial incentives from the manufacturer application 161.

The financial incentive support application 141 may include a reporting module for generating a report 157 that is sent to a manufacturer. The report includes information about the distribution of promotional offers for a given medication or for several medications manufactured by a particular manufacturer. The reporting module 155 accesses the promotions database 145 and determines the number of times a particular financial incentive has been provided to the electronic prescribing application 131. In an example embodiment, the reporting module 155 accesses the promotions database 145 and determines particular characteristics of patients to whom the financial incentive has been offered. For example, the reporting module 155 determines whether the financial incentive was requested by older patients or younger patients, whether the financial incentive was requested by low income patients or high income patients, whether the financial incentive was requested by patients with healthcare insurance plans or by those without one, etc. Such information is included in the report 157 and the report 157 is sent to a manufacturer of the corresponding medication(s). The manufacturer may use report 157 to create a marketing strategy, to create promotional offers, or to pay an operator of the financial incentive support application 141 for offering the manufacturer's promotional offers to patients.

The financial incentive support application may further include a patient follow-up module 159. The patient follow-up module 159 is configured to send follow-up communications pertaining to the medication prescribed to the patient. For example, the patient follow-up module 159 can monitor the dosage prescribed to the patient and send a refill reminder when the patient is expected to run on of the prescribed medication. This refill reminder can include another financial incentive for refilling the prescription, where the financial incentive is the same or different from the incentive provided when the medication was initially prescribed to the patient. The patient follow-up module 159 can also send a financial incentive for the same medication or a different medication independent from (i.e., at different time) a refill reminder.

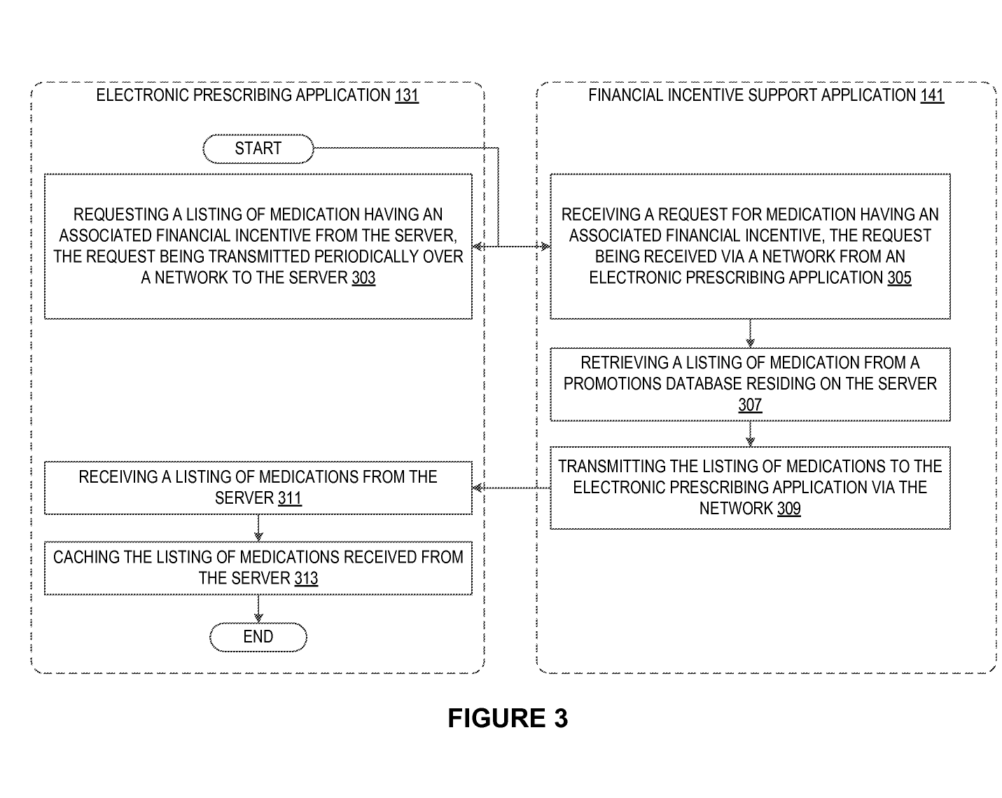

FIG. 3 is a flow diagram illustrating an example method for the electronic prescribing application 131 to retrieve identifiers of medications having promotional offers from the financial incentive support application 141.

The electronic prescribing application 131 requests the financial incentive support application 141 for identifiers of medications that have an associated promotional offer. In an example embodiment, the electronic prescribing application 131 requests for a listing of medications having an associated financial incentive. The request is transmitted over the public network 121. In an example embodiment, the request is transmitted periodically, for example at the end of each business day, once a week, or the like. In other embodiments, the request may be transmitted each time the electronic prescribing application 131 is loaded or initiated by the health care provider. In any case, the electronic prescribing application 131 transmits the request in response to receiving the request from the healthcare provider device 111. In an example embodiment, the request is transmitted using a Simple Object Access Protocol (SOAP). SOAP is a protocol specification for exchanging structured information in the implementation of Web Services in computer networks. It relies on Extensible Markup Language (XML) for its message format, and usually relies on other Application Layer protocols, most notably Hypertext Transfer Protocol (HTTP) or Simple Mail Transfer Protocol (SMTP), for message negotiation and transmission. In an example embodiment, the request for identifiers of medications includes:

<getProducts>
<key></key>
</getProducts>

In the above example embodiment, a request in being made for identifiers of all medication products that have a financial incentive associated with them. A key container contains a key that is provided by the financial incentive support application 141 to authorized users. The request is being transmitted from the electronic prescribing application 131 to the financial incentive support application 141 (Step 303). While reference is made to SOAP, it is readily understood that the broader aspects of this disclosure are applicable to other types of web service protocols.

The financial incentive support application 141 receives the request (Step 305). The tags are parsed and the key included in the key container between the ‘key’ tags is extracted. The key is verified for its authenticity. If the key is authentic then the medication request module 146 retrieves identifiers of all medication products that have financial incentives from the promotions database 145 (Step 307).

The financial incentive support application 141 transmits the identifiers of the medications (Step 309). In an example embodiment, the identifiers of medication products are transmitted in the following XML structural format:

```
<getProductsResponse>
  <product>
      <productId></productId>
      <productName></productName>
      <productDisclaimers>
        <productDisclaimer>
          <text></text>
          <url></url>
        </productDisclaimer>
      </productDisclaimers>
      <productIdentifiers>
        < RxNorm></RxNorm>
        <NDC></NDC>
      </productIdentifiers>
  </product>
  <alternativeOfferDescription/>
  <alternativeOfferLink/>
  <error/>
</getProductsResponse>
```

In the above example embodiment, there is a product container for holding product data. Zero or more product containers are expected. The product container includes a productid container that contains a string value of a unique identifier for a product in the promotions database 145. The product container includes a productName container that contains a string value describing the name of a drug with full description, for example “Lipitor 10 mg tablet”. The product container includes a productDisclaimers container that contains product National Drug Code (NDC) data and holds zero or more product disclaimers. The product container includes a productDisclaimer container that contains productDisclaimer text and a Uniform Resource Locator (URL) for the product disclaimer. The product container includes a text container that contains link text for the product disclaimer. The product container includes a URL container that contains a URL location for the product disclaimer. The product container includes a productidentifier container that contains an RxNorm code and NDC data. The product container includes a RxNorm container that contains a string value for the RxNorm code. The product container includes a NDC container that contains a string value of the NDC which can be nine or eleven characters long. The product container includes an error container that contains an error message, if applicable.

In an example embodiment, the financial incentive support application 141 only transmits changes in promotional availability of medications. In this example embodiment, if the promotional availability of a medication has not changed since the last transmittal of identifiers then an identifier of the medication is not transmitted. However, if the promotional availability of a medication has changed or a new medication has been added to the promotions database 145 since the last transmittal then an identifier of the medication is transmitted. Advantageously, by only transmitting changes to the promotions database 145 since the last transmittal, network bandwidth is conserved.

The electronic prescribing application 131 receives the identifiers of medications having financial incentives from the financial incentive support application 141 (Step 311).

The electronic prescribing application 131 stores the identifiers of the medications in the medication data store 136. In an example embodiment, the identifiers cached in a cache of the first server 133 although other types of storage mechanism are contemplated by this disclosure. Advantageously, by caching, the electronic prescribing application 131 can provide identifiers of medications with associated financial incentives to the healthcare provider device 111 quickly whenever the healthcare provider device 11 requests for such information and without having to request the identifiers from the financial incentive support application 141 over the public network 121 in response to every such request from the healthcare provide device 111. This reduces the latency of the system and improves system performance.

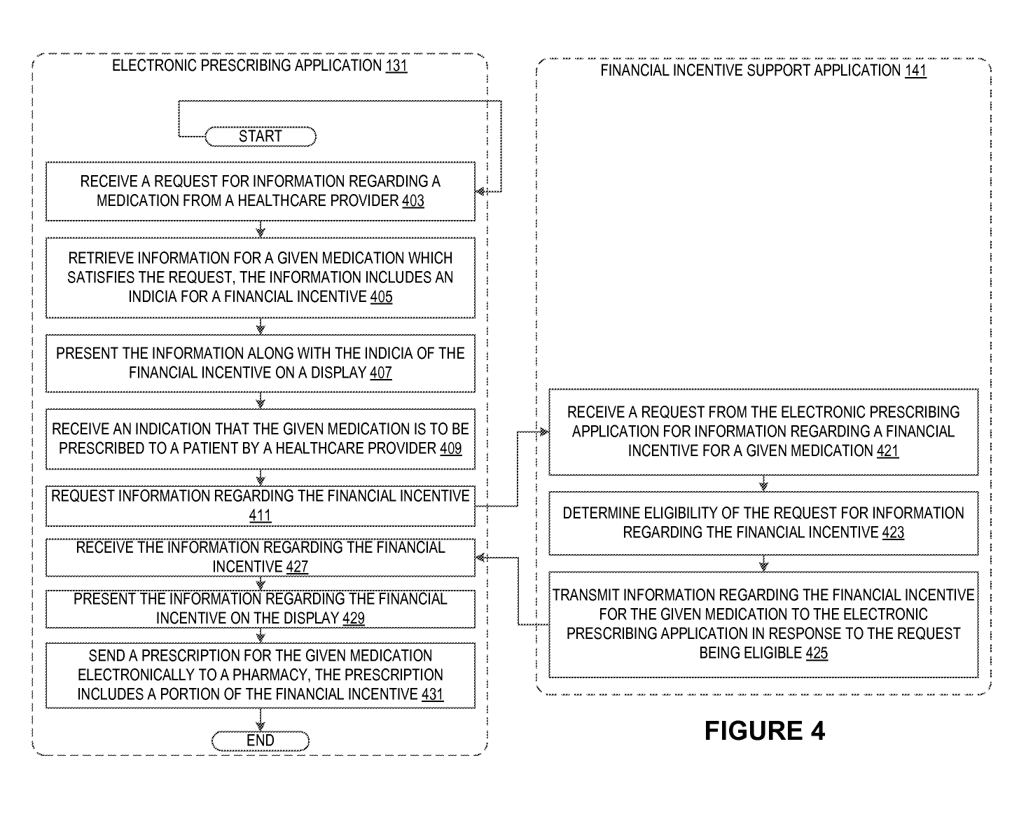

FIG. 4 is a flow diagram that illustrates an example method for promoting medications by providing information regarding financial incentives associated with medications to physicians while they are examining a patient and in the process of prescribing a medication to the patient.

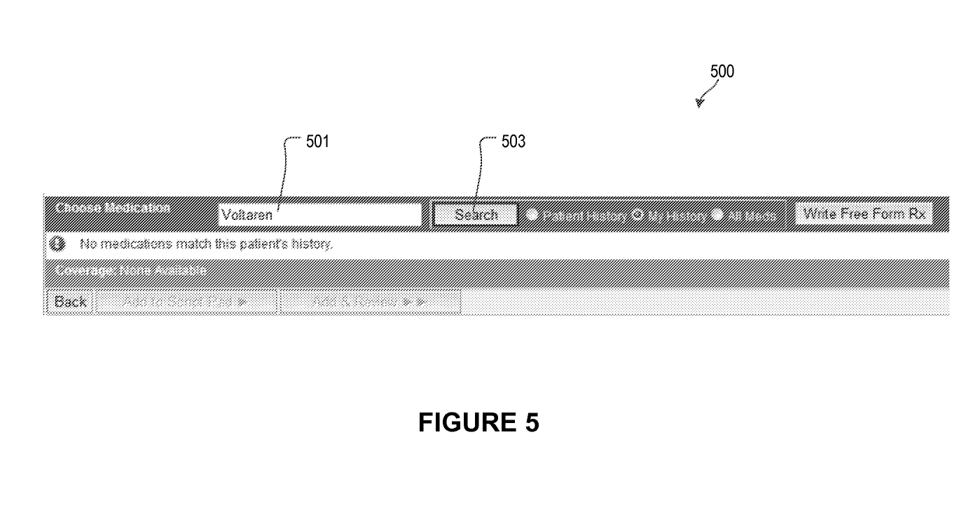

The electronic prescribing application 131 receives a request for information regarding a medication. The electronic prescribing application 131 receives the request from a healthcare provider device 111. The request includes a brand name of a medication or a generic name of a medication. FIG. 5 shows an example user interface 500 for querying the prescribing database. A healthcare provider such as a physician can enter the name of a medication in a medication field 501 and press a search button 503 to request for information regarding the medication entered in the medication field 501. In an example embodiment, the request includes a name of a medical disease or a medical condition, for example ‘migraine’, and the healthcare provider requests for names of medications that can be prescribed for ‘migraine’ and promotional information regarding the medications for ‘migraine’ (Step 403).

The query module 134 of the electronic prescribing application 131 retrieves medicinal information for a given medication that satisfies the request from the prescribing database 135. The query module 134 then checks the medication data store 136 to determine whether the requested medication has a promotional offer associated with it. If the query module 134 finds the requested medication in the medication data store 136, then the query module 134 retrieves indicia indicating the availability of a promotional offer for the requested medication. In an example embodiment, if medicinal information for the requested medication is not stored in the prescribing database 135, then the query module can retrieve the medicinal information for the requested medication from the manufacturer application 161. Similarly, if the requested medication is not stored in the medication data store 136, then the query module 134 can verify with the financial incentive support application 141 whether the requested medication has an associated promotional offer. In an example embodiment, the request for information from the healthcare provider device 111 includes a name of a medical disease or a medical condition. The query module 134 queries the prescribing database 135 for a medication that can be prescribed to a patient with the given medical disease or medical condition. When the query module 134 receives a name of a medication that can be prescribed to a patient with the given medical disease or condition, the query module 134 checks the medications data store 136 to determine whether there is a promotional offer associated with the medication. If yes, then the query module 134 retrieves indicia indicating the availability of the promotional offer. (Step 405)

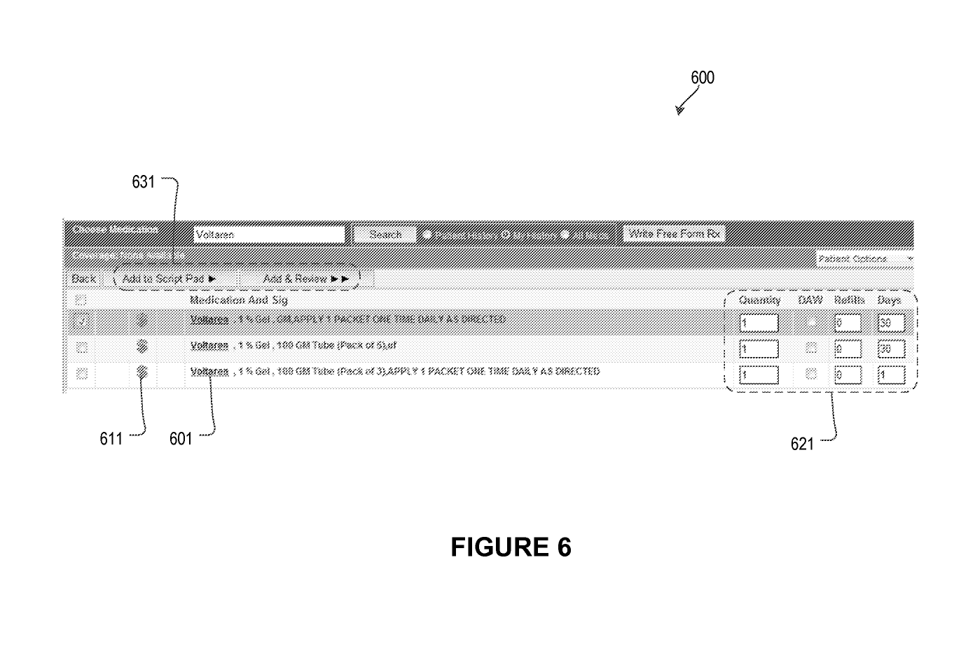

The electronic prescribing application 131 presents the identifier of the given medication along with the indicia of the financial incentive associated with the medication on a display of the healthcare provider device 111. FIG. 6 shows an example user interface 600 that displays a name of a medication 601 and an indicia 611 indicating the availability of a financial incentive associated with the medication 601. In an example embodiment, the electronic prescribing application 131 varies the output format so that it is suitable for the healthcare provider device 111. For example, if the healthcare provider device 111 includes a desktop computer then the electronic prescribing application 131 selects an output format with relatively large user interface elements that can be displayed on a relatively large display of the desktop computer. In another example, if the healthcare provider device 111 includes a mobile communication device such as a tablet or a smart phone then the electronic prescribing application 131 selects an output format with relatively small user interface elements that can be displayed on a relatively small display of the tablet or the smart phone. If the healthcare provider device 111 includes a mobile communication device such as a tablet or a smart phone then the information is compressed before it is transmitted to the healthcare provider device 111 so that the transmitting consumes less network bandwidth. (Step 407)

After the medication 601 and indicia 611 are displayed on the healthcare device 111, the healthcare provider completes prescription fields 621 to indicate that the medication 601 is to be prescribed to the patient. Examples of prescription fields 621 include a quantity of the medication 601, a number of refills of the medication 601, and a number of days for which the medication 601 is to be prescribed. The healthcare provider submits the information entered in the prescription fields 621 through submit options 631. The electronic prescribing application 131 receives the information entered in the prescription fields 621. The information indicates that the healthcare provider is prescribing the medication 601 to a patient. In an example embodiment, the information received by the electronic prescribing application 131 includes notes made by the healthcare provider or other information that may be needed to generate a prescription for the patient for the given medication such as any allergies that the patient may have. In an example embodiment, the electronic prescribing application 131 receives an age of the patient, whether the patient has a healthcare insurance plan, a type of the patient's healthcare insurance plan, whether the patient has a low income or any other information that may be needed in order to satisfy any eligibility criterion for the financial incentive indicated by indicia 611. (Step 409).

After receiving an indication that the healthcare provider is prescribing a medication to a patient, the electronic prescribing application 131 requests the financial incentive support application 141 for information regarding the financial incentive associated with the medication that is being prescribed. In an example embodiment, the information being requested now is different from the indicia because the information provides details regarding the financial incentive that can be used to apply the financial incentive, whereas the indicia simply indicates the mere existence or availability of a financial incentive without providing any details on the financial incentive. The request for information is transmitted over the public network 121 to the second server 143 of the financial incentive support application 141. In an example embodiment, the request is made in the following form:

```
<offersRequest>
  <key></key>
  <offersRequestParams>
      <amount></amount>
      <LastDatePrescribed></ LastDatePrescribed >
      < medicareMedicaid ></medicareMedicaid>
      <npi></npi>
      <patientAge></patientAge>
      <patientGender></patientGender>
      <practiceState></practiceState>
      <practiceZip></practiceZip>
      <prescriptionId></prescriptionId>
      <productld></productld>
      <rxnorm></rxnorm>
      <specialtyCode></specialtyCode>
      <systemID></systemID>
  <offersRequestParams>
</offersRequest>
```

In this example embodiment, there is an offersRequestParams container that serves as an XML container for the offer request parameters data. An amount container contains a numeric value indicating the number of coupons that are to be generated. If this container is left blank, then the default value is one. In an example embodiment, this container retains values from one to ten. A LastDatePrescribed container contains a date value of the last date on which the patient received a prescription for the medication that is being prescribed now. This container stores a date or is null. A medicareMedicaid container contains a Boolean value for any patient on either medicare or Medicaid programs. Examples of Boolean values are ‘false’, ‘true’, ‘yes’, ‘no’, ‘y’, ‘n’, ‘1’, and ‘0’. An npi container contains a string value that is a National Provider Identifier (NPI) for healthcare providers. This container may store values that are zero to ten characters in length. A patientAge container contains a string value representing an age of the patient. The age may be represented in months, years or days. A patientGender container contains a string value representing a gender of the patient. Examples values for the patientGender container are ‘M’ for male, ‘F’ for female, and ‘U’ for unknown or unidentified. A practiceState container contains a string value representing a State of the practice where the prescription was created. This container may hold two characters, for example ‘MI” for Michigan. A practiceZip container contains a string value representing a zip code or a postal code of the practice where the prescription was created. This container can hold five or nine characters. A prescriptionid container contains a string value representing a unique identifier associated with the prescription. This container may hold values that are as long as sixty four characters. A productid container contains a string value representing a unique identifier associated with a medication product. The electronic prescribing application 131 is requesting for information regarding a financial incentive associated with a medication having the identifier stored in the productid container. A productNDC container contains a string value representing the national drug code. This container may hold values that are nine or eleven characters long. A specialtyCode container contains a string value representing a specialty code corresponding with a specialty of the healthcare provider. A systemID container contains a string value representing a uniquely generated systemID. (Step 411) It is readily understood that the request may include more or less as well as other types of containers.

The financial incentive support application 141 receives the request for information regarding the financial incentive for a given medication via the second server 143 over the public network 121. In an example embodiment, the offer request module 147 receives the request in the XML structural form discussed above. The offer request module 147 uses an XML parser to parse the request and extract values from the XML containers. The offer request module 147 then sends the extracted values to the eligibility module 148 to determine the eligibility of the request. (Step 421)

The eligibility module 148 determines whether the request is eligible to receive the information regarding the financial incentive by comparing the XML container values with eligibility criteria for the financial incentive. (Step 423) Examples of eligibility criteria include a healthcare provider specialty criterion, a patient age criterion, a patient gender criterion, a last date prescribed criterion, a Medicare/Medicaid criterion, a practice State criterion, a patient income criterion, or the like.

The healthcare provider specialty criterion states that the financial incentive is available only to physicians with a certain specialty such as internal medicine. The eligibility module 148 uses a specialty code included in the request to determine the specialty of the healthcare provider. In an example embodiment, the eligibility module 148 determines that the physician's specialty is cardiology because the specialtyCode container contains a ‘C’, for example:
<specialtyCode>C</specialtyCode>
   The eligibility module 148 then compares the healthcare provider's specialty with the specialty specified in the specialty criterion of the financial incentive. If they match, then the request is eligible and the eligibility module 148 notifies the offer request module 147 that the request is eligible. In another example embodiment, the healthcare provider specialty is retrieved from a database using a healthcare provider identifier that the healthcare provider uses to access the electronic prescribing application 131. For example, if the healthcare provider is accessing the electronic prescribing application 131 using a healthcare provider identifier of ‘john_doe’ and the healthcare provider criterion associated with a medication states that a financial incentive is only available to physicians who specialize in internal medicine, then the eligibility module 148 retrieves healthcare provider information associated with ‘john_doe’ and determines whether the healthcare provider is a specialist in internal medicine. If the healthcare provider is a specialist in internal medicine then the eligibility determining module 148 notifies the offer request module 147 that the request is eligible for information regarding the financial incentive.

The patient age criterion states that the financial incentive is only available to patients who are of certain age. For example, the financial incentive is only available to patients who are older than sixty-five. In an example embodiment, the eligibility module 148 obtains the patient age stored in the patientAge container, for example:
<patientAge>69</patientAge>
   The eligibility module 148 then determines whether the patient satisfies the age criterion. If the age criterion is satisfied, then the eligibility module 148 notifies the offer request module 147 that the request is eligible for information regarding the financial incentive.

The patient income criterion states that the financial incentive is only available to patients with a certain income. For example, the financial incentive is only available to patients with an income lower than $20,000 per annum. The eligibility module 148 determines whether the patient satisfies the income criterion, for example by determining whether the patient's income is lower than $20,000. If the income criterion is satisfied, then the eligibility module 148 notifies the offer request module 147 that the request is eligible for information regarding the financial incentive.

The insurance criterion states that the financial incentive is only available to patients with a particular healthcare insurance plan. For example, the insurance criterion states that the financial incentive is only for patients who have Medicare or Medicaid. The eligibility module 148 determines whether the patient satisfies the insurance criterion, for example by determining whether the patient has medicare or Medicaid. The eligibility module 148 uses the value store in the medicareMedicaid container to determine whether patient has medicare or Medicaid, for example:
<medicareMedicaid>yes</medicareMedicaid>
   If the insurance criterion is satisfied, then the eligibility determining module 147 notifies the electronic prescribing application 131 that the request is eligible for information regarding the financial incentive.

The patient illness criterion states that the financial incentive is only available to patients with a terminal illness. The eligibility module 148 determines whether the patient satisfies the illness criterion by determining whether the patient is terminally ill. If the illness criterion is satisfied, then the eligibility module 148 notifies the electronic prescribing application 131 that the request is eligible for information regarding the financial incentive.

The manufacturer criterion is a criterion set by the manufacturer to promote the sale of the medication. In an example embodiment, the manufacturer criterion provides a financial incentive to a patient who is being prescribed a medication for the first time. In another example embodiment, the manufacturer criterion provides a financial incentive to a patient who was prescribed the medication in the past, for example to encourage repeat customers. The eligibility module 148 determines whether the patient has been prescribed the medication before by using the value stored in the LastDatePrescribed container. If the LastDatePrescribed container contains a null string, then the patient is being prescribed the medication for the first time, for example:
<LastDatePrescribed></LastDatePrescribed>
   In an example embodiment, the eligibility module 148 retrieves patient information from a patient database in the electronic prescribing application 131, compares the patient information with the required manufacturer criterion and notifies the offer request module 147 that the request is eligible for information regarding the financial incentive, if the patient information matches the manufacturer criterion.

In an example embodiment, a combination of the eligibility criterion described above is used to determine the eligibility of the request for information regarding the financial incentive. Other eligibility criterion can also be used by the eligibility module 148 to determine the eligibility of the request for information regarding the financial incentive. Other eligibility criterion can be specified by a manufacturer of the medication via the manufacture interface 153.

Determining eligibility for the request may also include selecting from amongst a plurality of qualified financial incentives. In some embodiments, a single financial incentive is associated with a given medication. In other embodiments, a plurality of financial incentives may be associated with a given medication. In this case, the eligibility module selects at least one of the plurality of financial incentives to present to the healthcare provider. Selections can be customized based on the information contained in the request, including but not limited to patient's age, patient's location, patient's insurance coverage or lack thereof, specialty of the healtchcare provider, diagnosis (e.g., disease) for the patient, etc. That is, the eligibility module selects a financial incentive based on one or more of the parameters received in the request. In one embodiment, the selection is made in accordance with rules defined by the manufacturer. Other types of selection mechanism or implementations for an expert system are also contemplated by this disclosure.

The offer request module 147 retrieves information regarding the financial incentive from the promotions database 145 and transmits the information to the electronic prescribing application 131, after the eligibility module 148 has determined that the request is eligible to receive the information regarding the financial incentive (Step 425). In an example embodiment, if the eligibility module 148 determines that the request is not eligible for the information regarding the financial incentive, then the offer request module 147 transmits the information regarding the financial incentive along with a warning notification. The warning notification indicates that the patient may not be eligible for the financial incentive. For example, the warning notification indicates that the financial incentive is only for senior citizens and the patient is not a senior citizen. In an example embodiment, if the eligibility module 148 determines that the request is not eligible for the information regarding the financial incentive, then the offer request module 147 transmits the eligibility criterion for the financial incentive and indicates that the request does not satisfy the eligibility criterion. For example, the offer request module 147 transmits that the financial incentive is only available for senior citizens and that the financial incentive is not available for the patient because the patient is not a senior citizen. In an example embodiment, the offer request module 147 is a part of the eligibility module 148.

The information regarding the financial incentive includes a financial incentive identifier that is provided by the manufacturer of the medication. In an example embodiment, the financial incentive identifier includes a code such as a coupon code or a voucher code, which can be applied when the medication is being purchased by the patient to reduce the cost of the medication. In an example embodiment, the financial incentive identifier includes alphanumeric characters, a bar code, a two dimensional bar code, a Quick Response (QR) code, or the like.

Information sent to the electronic prescribing application 131 may also include patent educational information, such as information about the medication or the patient condition being treated. The offer request module 147 may be configured to select the patient educational information which is to accompany the financial incentive. Selection of patient education information can be customized based on the information contained in the request, including but not limited to patient's age, patient's location, patient's insurance coverage or lack thereof, specialty of the healthcare provider, diagnosis (e.g., disease) for the patient, etc. In one embodiment, the selection is made in accordance with rules defined by the manufacturer. Other types of selection mechanism or implementations for an expert system are also contemplated by this disclosure.

The electronic prescribing application 131 receives the information regarding the financial incentive from the financial incentive support application 141 (Step 427). In an example embodiment, the electronic prescribing application 131 receives information regarding the financial incentive in an XML format, such as:

```
<getOffersResponse>
  <offer>
      <adjudicationId></adjudicationId>
      <bin></bin>
      <description></description>
      <group></group>
      <id></id>
      <issuer></issuer>
      <offerHTMLUrl></offerHTMLUrl>
      <offerImageUrl></offerImageUrl>
      <offerPDFUrl></offerPDFUrl>
      <pcn></pcn>
      <pharmacyNotes></pharmacyNotes>
      <transactionId></transactionId>
      <prescriptionId></prescriptionId>
  </offer>
</getOffersResponse>
```

In the above example XML response, an offer container contains various offer variables. An adjudicationid container contains a string representing a unique adjudication identifier for the offer. The adjudication identifier is an identifier that is assigned by the medication manufacturer. The adjudication identifier may have a length of one to twenty five characters. A bin container contains a string representing a six digit bank identification number (BIN) indicating who is paying for the claim. A description container contains a description for the offer. A group container contains a string representing a group. An id container contains a string value of a unique identifier integer for the offer that may be assigned by the manufacturer. An issuer container contains a string representing an issuer of the promotional offer. An offerHTMLUrl container contains an HTML (Hyper Text Markup Language) page URL for the offer. An offerImageUrl contains a URL for an image of the offer. An offerPDFUrl contains a PDF (Portable Document Format) URL of the offer. A pcn container includes a string representing a PCN for the offer. A pharmacyNotes container contains a string representing the BIN, Group, adjudicationID, and any other notes to the pharmacy that the pharmacy may use in preparing the prescribed medication. A prescriptionid container contains a string value of a unique identifier for the prescription. A transactionid container contains a string value of a unique identifier for an offer transaction integer.

The electronic prescribing application 131 parses the XML response using an XML parser to selectively extract relevant information stored in the XML containers between corresponding XML tags. In an example embodiment, the electronic prescribing application 131 receives the information regarding the financial incentive using SOAP. In another example embodiment, the electronic prescribing application 131 receives the information in Portable Document Format (PDF); the PDF can include text, an image, and/or a bar code. In an example embodiment, the electronic prescribing application 131 receives a link to the information regarding the financial incentive. The link points to a server where the information regarding the financial incentive is stored. If the server requires login credentials to provide access, then the electronic prescribing application 131 receives the login credentials from the financial incentive support application 141.

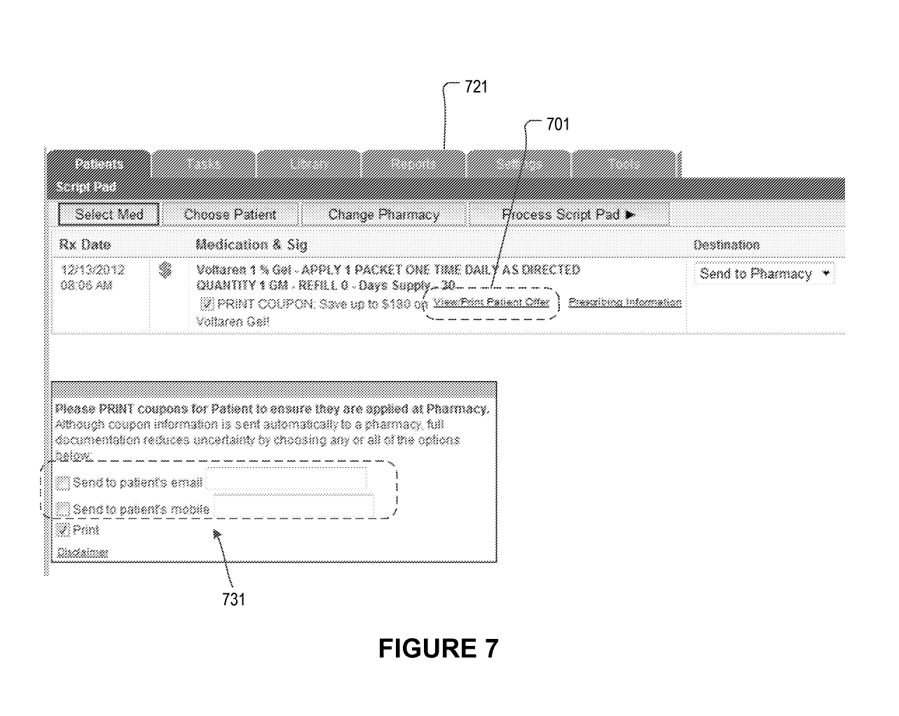

The electronic prescribing application 131 presents the information regarding the financial incentive on a display of the healthcare provider device 111 (Step 429). In an example embodiment, the electronic prescribing application 131 presents the information on a display of the healthcare provider device 111 through a web-based user interface. In another example embodiment, the electronic prescribing application 131 presents the information regarding the financial incentive by outputting the information via a speaker of the healthcare provider device 111. FIG. 7 illustrates another example embodiment, in which the electronic prescribing application 131 displays a link 701 to the information regarding the financial incentive. The healthcare provider can click the link 701 and view details regarding the financial incentive. It is envisioned that the link may be replaced by an icon on the display. Likewise, patient educational information accompanying the financial incentive may be presented in similar manners to the healthcare provider. In this case, a link (or icon) may be provided for financial incentive and a second separate link (or icon) may be provided for the patient educational information. The healthcare provider can elects to print the information pertaining to financial incentive and/or the patient education information and provide it directly to the patient.

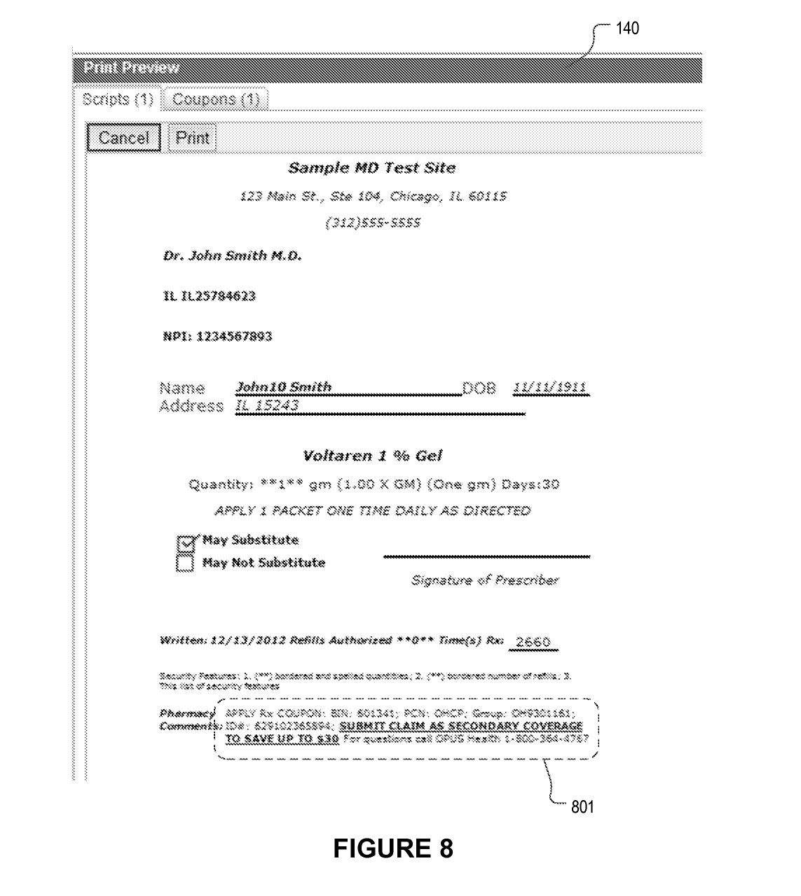

The electronic prescribing application 131 generates a prescription 140 using the prescribing module 139, after receiving a command 721 from the healthcare provider device 111 to send a prescription to the pharmacy. The prescribing module 139 generates the prescription 140 and electronically sends the prescription 140 to the pharmacy device 151 over the public network 121. The prescription 140 includes a portion of the information regarding the financial incentive associated with the medication. In an example embodiment, the prescription 140 includes a coupon code or a voucher code that can be redeemed at the pharmacy device 151 or a point-of-sale terminal at the pharmacy to reduce the price of the medication for the patient thereby reducing the patient's healthcare costs. The prescription includes prescribing information such as an amount of the medication that is to be prescribed, dosage information indicating the frequency at which the patient should take the medication, number of refills that the patient is entitled to, or any other information that the healthcare provider chooses to include in the prescription. FIG. 8 shows an example prescription 140 with a portion 801 of the financial incentive being included in the prescription 140, so that the financial incentive can be used at the pharmacy to reduce the cost of the prescription to the patient. In an example embodiment, the financial incentive data is integrated into a comment field which is generally available in electronic prescribing applications. As can be seen in FIG. 7, the healthcare provider may send the prescription to the patient via email or via a text message over the cellular network by entering the patient's email address or the patients mobile number in the fields 731.

The electronic prescribing application 131 may send a confirmation to the financial incentive support application 141 indicating that the promotional offer was delivered to the pharmacy successfully. In an example embodiment, the confirmation includes the following XML containers:

```
<confirmation>
  <key></key>
  <transactions>
      <transaction>
        <email></email>
        <esent></esent>
        <fax></fax>
        <mobile></mobile>
        <printed></printed>
        <transactionId></transactionId>
      <transaction>
    ...
  </transactions>
</confirmation>
```

A transactions container contains information about promotional offers being delivered. A transaction container contains information about a single promotional offer that was delivered. An email container contains an email address of the promotional offer's recipient, for example an email address of a patient. An esent container contains a Boolean value to identify whether the offer was electronically sent to a pharmacy. Example values are ‘true’, ‘false’, ‘y’, ‘n’, ‘1’, and ‘0’. A fax container contains a boolean value to identify whether the promotional offer has been faxed. Example values are ‘true’, ‘false’, ‘y’, ‘n’, ‘1’, and ‘0’. A mobile container contains a mobile phone number to which the promotional offer was sent over a cellular network. A printed container contains a Boolean value to identify whether the offer has been printed to a printer peripheral. A transactionalid container contains a string value of the unique identifier for the offer transaction.

The financial incentive support application 141 may send an acknowledgement in response to receiving a confirmation from the electronic prescribing application 131. In an example embodiment, the acknowledgement includes the following XML containers:

<return>
<success>Transaction Complete</success>
</return>

A success container contains a message that the transaction has been successfully completed.

The electronic prescribing application 131 may send a cancellation to the financial incentive support application 141 indicating that the adjudicated offer was not delivered successfully. In an example embodiment, the cancellation includes the following XML containers:

```
<cancellation>
  <key></key>
  <transactions>
      <transaction>
        <transactionId></transactionId>
        <reason></reason>
      <transaction>
      <transaction>
        <transactionId></transactionId>
        <reason></reason>
      <transaction>
    ...
  </transactions>
</ cancellation >
```

A reason container contains an explanation as to why the transaction has been cancelled. The financial incentive support application 141 may send an acknowledgement of the cancellation, similar to the acknowledgement of the confirmation discussed above.

The electronic prescribing application 131 may send another confirmation to the financial incentive support application 141 indicating whether the prescription has been filled or not. If the prescription has not been filled, then the electronic prescribing application 141 may send a reason for the prescription not being filled. In an example embodiment, the confirmation includes the following XML containers:

```
<filledininfo>
  <key></key>
  <transactions>
      <transaction>
        <transactionId></transactionId>
        <filledin></filledin>
        <reason></reason>
      <transaction>
      <transaction>
        <transactionId></transactionId>
        <filledin></filledin>
        <reason></reason>
      <transaction>
    ...
  </transactions>
</ filledininfo >
```

A filledin container contains Boolean value indicating whether prescription has been filled. Example values include ‘yes’, ‘no, ‘y’, ‘n’, ‘1’, and ‘0’. The financial incentive support application 141 may send an acknowledgement in response to receiving the confirmation indicating whether the prescription was filled or not.

The financial incentive support application 141 may receive confirmation and cancellation notifications from the pharmacy device 151. In an example embodiment, the pharmacy device 151 notifies the financial incentive support application 141 that a financial incentive supplied by the financial incentive support application 141 was used in the purchase of the medication. In an example embodiment, the pharmacy device 151 sends the notifications directly to the financial incentive support application 141 over the public network 121. In another example embodiment, the pharmacy device 151 sends notifications to the financial incentive support application 141 through the electronic prescribing application 131.

The financial incentive support application 141 may include a reporting module 155 that conveys information regarding the distribution and usage of financial incentives. The reporting module 155 generates a report 157 and sends the report 157 to the manufacture application 161. In an example embodiment, the report 157 includes a number of times that a particular financial incentive was provided to the electronic prescribing application 131. In another example embodiment, the report 157 includes a number of confirmations indicating the number of times a particular financial incentive was electronically delivered. In another example embodiment, the report 157 includes a number of cancellations indicating the number of times a particular financial incentive was provided to the electronic prescribing application 131 but not electronically delivered to a pharmacy. The report 157 may include other statistical information, such as whether the financial incentive was provided to seniors, patients with low income, patients with Medicare/Medicaid, etc. The report 157 may allow a manufacturer to track the effectiveness of their financial incentives in the promotional offers, for example by tracking the percentage of financial incentives that were acted upon.

The reporting module 155 may be further configured to provide data regarding the distribution of financial incentives to an interface for an electronic health record system accessible to patients. Patient portals have been developed which provide patients access to their health records. When a particular financial incentive has been provided to a given patient, the reporting module 155 can also send information for the financial incentive to an applicable electronic health record system associated with the given patient. Such information can be sent using web service protocols in the manner described above. Upon receipt of the information for the particular financial incentive, an interface for the electronic health record system updates the given patient's records with the information. The reporting module 155 may send the information contemporaneously with delivering the financial incentive to the electronic prescribing application or some time thereafter. In this way, the patient has visibility and access to the financial incentives provided to them via the electronic health record system.

The techniques described herein may be implemented by one or more computer programs executed by one or more processors. The computer programs include processor-executable instructions that are stored on a non-transitory tangible computer readable medium. The computer programs may also include stored data. Non-limiting examples of the non-transitory tangible computer readable medium are nonvolatile memory, magnetic storage, and optical storage.

Some portions of the above description present the techniques described herein in terms of algorithms and symbolic representations of operations on information. These algorithmic descriptions and representations are the means used by those skilled in the data processing arts to most effectively convey the substance of their work to others skilled in the art. These operations, while described functionally or logically, are understood to be implemented by computer programs. Furthermore, it has also proven convenient at times to refer to these arrangements of operations as modules or by functional names, without loss of generality.

Unless specifically stated otherwise as apparent from the above discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system memories or registers or other such information storage, transmission or display devices.

Certain aspects of the described techniques include process steps and instructions described herein in the form of an algorithm. It should be noted that the described process steps and instructions could be embodied in software, firmware or hardware, and when embodied in software, could be downloaded to reside on and be operated from different platforms used by real time network operating systems.

The present disclosure also relates to an apparatus for performing the operations herein. This apparatus may be specially constructed for the required purposes, or it may comprise a general-purpose computer selectively activated or reconfigured by a computer program stored on a computer readable medium that can be accessed by the computer. Such a computer program may be stored in a tangible computer readable storage medium, such as, but is not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each coupled to a computer system bus. Furthermore, the computers referred to in the specification may include a single processor or may be architectures employing multiple processor designs for increased computing capability.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A computer-implemented method for promoting prescription medication, comprising:
receiving, by an electronic prescribing application, a request for information regarding a medication from a healthcare provider;
retrieving, by the electronic prescribing application, information for a given medication which satisfies the request for information, where the information for the given medication includes an indicia of a financial incentive associated with the given medication and the retrieval being performed in response to the request for information;
presenting, by the electronic prescribing application, the given medication, along with the indicia of a financial incentive, on a display;
receiving, by the electronic prescribing application, an indication that the given medication is to be prescribed to a patient by the healthcare provider;
requesting, by the electronic prescribing application, information regarding the financial incentive, the request being transmitted over a network to a server and the request being performed in response to receiving the indication that the given medication is to be prescribed;
receiving, by the electronic prescribing application, the information regarding the financial incentive from the server;
presenting, by the electronic prescribing application, the information regarding the financial incentive on the display; and
sending, by the electronic prescribing application, a prescription for the given medication electronically to a pharmacy, where the prescription includes a portion of the information regarding the financial incentive and the electronic prescribing application is implemented by computer-readable instructions executed by a computer processor residing on a host computing device.

2. The method of claim 1 further comprising:
storing information for medications in a prescribing database residing on the host computing device, wherein the electronic prescribing application retrieves information for the given medication from the prescribing database.

3. The method of claim 1 further comprising:
requesting, by the electronic prescribing application, a listing of medications having an associated financial incentive from the server, the request being transmitted periodically over a network to the server;
receiving, by the electronic prescribing application, a listing of medications from the server, the listing of medication being provided in response to the request for a listing of medications;
caching, by the electronic prescribing application, the listing of medications received from the server.

4. The method of claim 1 further comprises requesting information regarding the financial incentive in accordance with a web service protocol.

5. The method of claim 1 wherein the request for information regarding the financial incentive includes identifying data for the given medication, identifying data for the patient, and identifying data for the healthcare provider.

6. The method of claim 1 wherein the information regarding the financial incentive includes a unique identifier for the financial incentive assigned by the manufacturer of the given medication.

7. The method of claim 1 further comprising
delivering, by the electronic prescribing application, a manifestation of the financial incentive to the patient.

8. The method of claim 1 wherein receiving the indication that the given medication is to be prescribed further comprises receiving at least one of a quantity of given medication or a duration for the prescription from the healthcare provider.

9. The method of claim 1 further comprising:
receiving, by the electronic prescribing application, a notification from the server explaining ineligibility of the request for the information regarding the financial incentive; and
presenting, by the electronic prescribing application, the notification explaining ineligibility of the request on the display.

10. A computer-implemented method for promoting prescription medication, comprising:
receiving, by an incentive support application, a request for medications having an associated financial incentive, wherein the request being received via a network from an electronic prescribing application and the incentive support application implemented by computer-readable instructions executed by a computer processor residing on a server;
retrieving, by the incentive support application, identifiers of medications from a promotions database residing on the server, the retrieval being performed in response to the request for medications;
transmitting by the incentive support application, the identifiers of medications to the electronic prescribing application, the identifiers of medications being transmitted via the network to the electronic prescribing application;
receiving, by the incentive support application, a request for information regarding a financial incentive for a given medication, the request being received via the network from the electronic prescribing application;
determining, by the incentive support application, eligibility of the request for information regarding a financial incentive, the determination being performed in response to the request for information;
transmitting, by the incentive support application, information regarding the financial incentive for the given medication to the electronic prescribing application, the transmission occurring in response to the determination that the request for information is eligible.

11. The method of claim 10 further comprising:
authenticating, by the incentive support application, the request of medications using an authentication token embedded in the request.

12. The method of claim 10 wherein the request for information regarding the financial incentive includes identifying data for the given medication, identifying data for the patient, and identifying data for the healthcare provider.

13. The method of claim 12 wherein the identifying data for the healthcare provider includes a specialty of the healthcare provider; and wherein determining eligibility of the request for information further comprises determining whether the specialty of the healthcare provider matches a specialty criterion for the financial incentive.

14. The method of claim 12, wherein the identifying data for the patient includes an age of the patient; and wherein determining eligibility of the request for information further comprises determining whether the age of the patient matches an age criterion for the financial incentive.

15. The method of claim 12, wherein the identifying data for the patient includes a date on which the given medication was last prescribed to the patient; and wherein determining eligibility of the request for information further comprises determining whether the date on which the given medication was last prescribed to the patient matches a last prescription date criterion for the financial incentive.

16. The method of claim 12, wherein determining eligibility of the request for information further comprises determining whether the identifying data for patient and the identifying data for the healthcare provider matches a manufacturer criterion for the financial incentive.

17. The method of claim 10 further comprises transmitting information regarding the financial incentive in accordance with a web service protocol.

18. The method of claim 10 wherein the information regarding the financial incentive includes a unique identifier for the financial incentive assigned by the manufacturer of the given medication.

19. A computer-implemented system for promoting prescription medication, comprising:
a prescribing database that resides on a first computing device and operates to store information regarding medications;
a data store on the first computing device that stores identifiers of medications having a financial incentive associated therewith;
a query module residing on the first computing device and configured to receive a query for information regarding medication from a healthcare provider, the query module operates, in response to the query, to retrieve information for a given medication which satisfies the query from the prescribing database, determines whether the given medication has an associated financial incentive by accessing the data store, and delivers the information for the given medication, along with an indicia of a financial incentive associated with the given medication, to a device associated with the healthcare provider;
a prescribing module residing on the first computing device and configured to receive an indication that the given medication is to be prescribed to a patient by the healthcare provider, the prescribing module operates, in response to receiving the indication that the given medication is to be prescribed, to request information regarding the financial incentive, wherein the request is transmitted over a network to a server located remotely from the first computing device,
an eligibility module on the server and configured to receive the request for information regarding the financial incentive from the prescribing module, the eligibility module operates, in response to the request, to determine eligibility for the request and transmits information regarding the financial incentive to the prescribing module in response to a determination that the request for information is eligible; and
the prescribing module further configured to receive the information regarding the financial incentive from the server and send a prescription for the given medication electronically to a pharmacy, where the prescription includes a portion of the information regarding the financial incentive.

20. The computer-implemented system of claim 19 further comprising:
a promotions database on the server that stores identifiers of medications and financial incentives associated with the medications;
a medication retrieval module residing on the first computing device and configured to request the server for identifiers of medications having a financial incentive associated therewith, the request being transmitted periodically over a network to the server;
a medication request module residing on the server and configured to receive the request for identifiers of medications having a financial incentive associated therewith, the medication request module, operates in response to the request, to retrieve identifiers of medications which satisfy the request from the promotions database, and transmits the identifiers of medications to the medication retrieval module; and
the medication retrieval module further configured to receive the identifiers of medications having a financial incentive associated therewith, and store the identifiers of medications in the data store.

21. The computer-implemented system of claim 19, wherein the prescribing module is configured to request the information regarding the financial incentive in accordance with a Simple Object Access Protocol (SOAP) and the eligibility module is configured to transmit the information regarding the financial incentive in accordance with SOAP.

22. The computer-implemented system of claim 19, wherein the prescribing module is further configured to electronically send the information regarding the financial incentive to a device associated with a patient.

23. The computer-implemented system of claim 19, wherein the information regarding the financial incentive includes a unique identifier for the financial incentive assigned by the manufacturer of the given medication.

24. The computer-implemented system of claim 19, wherein the eligibility module is configured to determine the eligibility for the request by determining whether a specialty associated with the healthcare provider matches a specialty criterion for the financial incentive.

25. The computer-implemented system of claim 19, wherein the eligibility module is configured to determine the eligibility for the request by determining whether an age associated with the patient matches an age criterion for the financial incentive.
